(19) United States
(12) Patent Application Publication
(10) Pub. No.: US 2007/0212077 A1
(43) Pub. Date: Sep. 13, 2007

(54) Ultra Wideband Communication System, Transmission Device Reception Device, and Replay Device Used for the Same

(76) Inventors: Toshihiko Yasue, Osaka (JP); Toru Shiozaki, Kyoto (JP); Masaru Fuse, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/587,012

(22) PCT Filed: Jun. 10, 2005
(86) PCT No.: PCT/JP05/10702

§ 371 Date: Oct. 20, 2006

(30) Foreign Application Priority Data
Jun. 16, 2004 (JP) 2004-177854

(51) Int. Cl. H04B 10/04; H04B 10/12

(52) U.S. Cl. 398/188

(57) ABSTRACT

The ultra wideband communication system comprises: a pulse generation section for generating a pulse signal based on a data signal; a first optical phase modulation section for performing optical phase modulation in accordance with the pulse signal, and outputting a resultant signal as an optical pulse signal; an optical transmission path for propagating the optical pulse signal; a template generation section for outputting a template signal; a second optical phase modulation section for performing optical phase modulation on the optical pulse signal in accordance with the template signal, and outputting a resultant signal as an optical phase demodulation signal; an optical phase intensity conversion section for converting information about an optical phase of the optical phase demodulation signal into information about an optical intensity thereof, and outputting a resultant signal as an optical correlation signal; an optical-electrical conversion section for performing optical-electrical conversion on the optical correlation signal, and outputting a resultant signal as a correlation signal; and a signal identification section for identifying the correlation signal outputted from the optical-electrical conversion section, thereby detecting the data signal.

### TECHNICAL FIELD

The present invention relates to an ultra wideband communication system called UWB (Ultra Wide Band) for transmitting a light, which has been modulated by using a short-pulse signal which is an ultra wideband signal, and demodulating the light. The present invention particularly relates to an ultra wideband communication system in which correlation processing for demodulating the light is performed in a distinctive manner.

### BACKGROUND ART

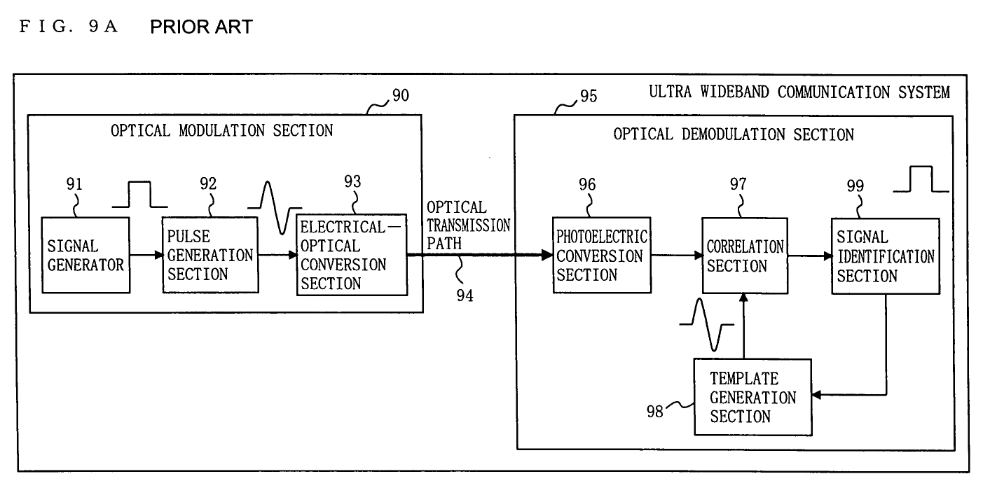

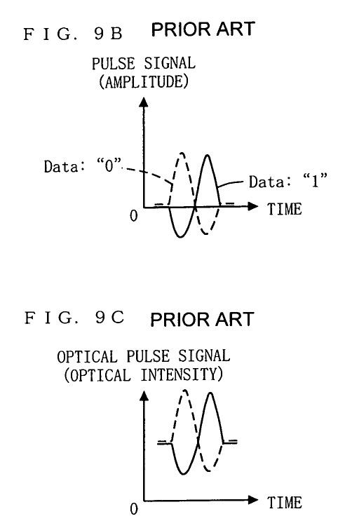

Conventionally, there has been an ultra wideband communication system in which correlation processing is performed electrically (refer to, e.g., a patent document 1). Also, there has been a proposed system for converting an electrical pulse signal into an optical signal, transmitting the optical signal on an optical transmission path, and demodulating the optical signal into an electrical pulse signal (refer to, e.g., International Publication WO 2004/082175). FIG. 9A is a block diagram showing an ultra wideband communication system as a result of: extracting, from a conventional ultra wideband communication system disclosed in the patent document 1, component elements relating to the present invention; and adding, to the extracted component elements, component elements required for performing optical transmission which are disclosed in International Publication WO 2004/082175.

A configuration of such a conventional ultra wideband communication system is described below. In FIG. 9A, the conventional ultra wideband communication system performs a transmission of a data signal from an optical modulation section 90 to an optical demodulation section 95 via an optical transmission path 94. The optical modulation section 90 comprises a signal generation section 91, a pulse generation section 92 and an electrical-optical conversion section 93. The optical demodulation section 95 comprises an optical-electrical conversion section 96, a correlation section 97, a template generation section 98 and a signal identification section 99.

FIG. 9B shows waveforms of pulse signals outputted from the pulse generation section 92. FIG. 9B shows, with a dashed line, a waveform corresponding to data “0”, and shows, with a solid line, a waveform corresponding to data “1”. FIG. 9C shows waveforms of optical pulse signals outputted from the electrical-optical conversion section 93. FIG. 9C also shows, with a dashed line, a waveform corresponding to data “0”, and shows, with a solid line, a waveform corresponding to data “1”.

Hereinafter, operations of a conventional ultra wideband communication device will be described with reference to FIGS. 9A to 9C. In the optical modulation section 90, the signal generation section 91 outputs a data signal to be transmitted. The pulse generation section 92 generates a pulse signal (refer to FIG. 9B) based on the data signal outputted from the signal generation section 91, and outputs the pulse signal. The electrical-optical conversion section 93 performs optical intensity modulation on the pulse signal outputted from the pulse generation section 92, and outputs a resultant signal as an optical pulse signal (refer to FIG. 9C).

The optical transmission path 94 propagates the optical pulse signal outputted from the electrical-optical conversion section 93.

In the optical demodulation section 95, the optical-electrical conversion section 96 converts the optical pulse signal having propagated through the optical transmission path 94 (refer to FIG. 9C) into a pulse signal (refer to FIG. 9B), and outputs the pulse signal. The template generation section 98 generates a pulse having a correlation with the pulse signal, and outputs the pulse as a template signal. The correlation section 97, which is structured by, e.g., an electrical mixer, multiplies amplitude information about the pulse signal outputted from the optical-electrical conversion section 96 by amplitude information about the template signal outputted from the template generation section 98, thereby obtaining a correlation between the pulse signal and the template signal, and then outputs a resultant signal as a correlation signal. Hereinafter, processing by the correlation section 97 for obtaining the correlation between the pulse signal and the template signal will be referred to as correlation processing. The signal identification section 99 integrates the correlation signal outputted from the correlation section 97, thereby identifying the data signal transmitted from the optical modulation section 90.

An operation related to each signal (data signal, pulse signal, optical pulse signal, template signal and correlation signal) which is performed for correlation processing will be described in detail. As shown by the waveforms of FIG. 9B, when a data signal is “1”, the pulse generation section 92 generates a pulse signal having a polarity in which an amplitude of the pulse signal changes from minus to plus, whereas when a data signal is “0”, the pulse generation section 92 generates a pulse signal having an opposite polarity to that of the pulse signal generated when the data signal is “1”. The electrical-optical conversion section 93 converts the amplitude of the pulse signal into optical intensity information, and generates an optical pulse signal having a same polarity as that of the pulse signal. The template generation section 98 generates a pulse, which has a fixed polarity regardless of a content of the data signal, i.e., a predetermined template signal. Consequently, a value, which is indicated by a correlation signal obtained from multiplying the amplitude information about the pulse signal by the amplitude information about the template signal, is different between a case where the pulse signal and template signal have a same polarity and a case where the pulse signal and template signal respectively have different polarities. This allows the signal identification section 99 to recognize whether the data signal is “1” or “0” by integrating the correlation signal over one cycle of one optical pulse signal. Note that, the optical modulation section 90 and the optical demodulation section 95 are synchronized in a conventional manner. In accordance with such synchronization, the correlation section 97 obtains a correlation between the template signal and the pulse signal.
[Patent Document 1] Japanese National Phase PCT Laid-Open Publication No. 11-504480 (page 47, FIG. 17)

### DISCLOSURE OF THE INVENTION

### Problems to be Solved by the Invention

In the above-described conventional system configuration, the optical demodulation section 95 performs correlation processing by using the correlation section 97 such as an electrical mixer. Generally speaking, it is difficult to obtain a wideband frequency characteristic by an electrical mixer. Therefore, in the conventional system configuration as shown in FIG. 9A, there is a problem that a quality of correlation processing is prone to deteriorate.

In addition, when the above-described optical transmission of pulse signals is used for wavelength division multiplexed transmission, each of the number of correlation sections and the number of template generation sections is required to correspond to the number of wavelengths. This results in a problem that a device for the system increases in size.

Therefore, an object of the present invention is to provide an ultra wideband communication system capable of preventing a deterioration of a quality of correlation processing. Another object of the present invention is to provide an ultra wideband communication system which is: capable of preventing a deterioration of a quality of correlation processing; capable of preventing a device for the system from increasing in size; and applicable for wavelength division multiplexing.

### Solution to the Problems

In order to solve the above-mentioned problems, the present invention has the following features. A first aspect of the present invention is an ultra wideband communication system for converting a pulse signal into an optical pulse signal, transmitting the optical pulse signal, and demodulating the transmitted optical pulse signal, the system comprising at least one pulse generation section for generating the pulse signal based on a data signal; at least one first optical phase modulation section for performing optical phase modulation in accordance with the pulse signal generated by the pulse generation section, and outputting a resultant signal as the optical pulse signal; an optical transmission path for propagating the optical pulse signal outputted from the first optical phase modulation section; a template generation section for generating a pulse which has a correlation with the pulse signal and which has a predetermined waveform, and outputting the pulse as a template signal; a second optical phase modulation section for, in accordance with the template signal outputted from the template generation section, performing optical phase modulation on the optical pulse signal propagated through the optical transmission path, and outputting a resultant signal as an optical phase demodulation signal; an optical phase intensity conversion section for converting information about an optical phase of the optical phase demodulation signal outputted from the second optical phase modulation section into information about an optical intensity thereof, and outputting a resultant signal as an optical correlation signal; at least one optical-electrical conversion section for performing optical-electrical conversion on the optical correlation signal outputted from the optical phase intensity conversion section, and outputting a resultant signal as a correlation signal; and at least one signal identification section for detecting the data signal by identifying the correlation signal outputted from the optical-electrical conversion section.

According to the first aspect of the present invention, a first optical phase modulation is performed at the transmitting end in accordance with the pulse signal, and as a result, the optical pulse signal is outputted. The optical pulse signal is propagated, and a second optical phase modulation is performed at the demodulating end in accordance with the template signal. By the second optical phase modulation, a phase of the optical pulse signal is added to a phase of the template signal, and as a result, the optical phase demodulation signal having correlations with the optical pulse signal and the template signal is outputted. The optical phase intensity conversion section converts information about an optical phase of the optical phase demodulation signal into information about an optical intensity thereof, and as a result, the optical phase demodulation signal is converted into the optical correlation signal. By converting the optical correlation signal into an electrical signal, a correlation between the pulse signal based on the original data signal and the template signal is obtained. Accordingly, the original data signal can be detected by identifying the correlation signal. Thus, the present invention provides an ultra wideband communication system, which performs correlation processing by using an optical device and which is capable of preventing a deterioration of a quality of correlation processing.

In a second aspect of the present invention, more than two: pulse generation sections; first optical phase modulation sections; optical-electrical conversion sections; and signal identification sections are provided. The ultra wideband communication system further comprises: a wavelength division multiplexing section for performing wavelength division multiplexing of optical pulse signals respectively outputted from the first optical phase modulation sections, and then propagating the optical pulse signals through the optical transmission path; and a wavelength demultiplexing section provided on an output side of the optical phase intensity conversion section. The second optical phase modulation section performs, in accordance with the template signal outputted from the template generation section, optical phase modulation on a plurality of optical pulse signals multiplexed by the wavelength division multiplexing section, and outputs resultant signals as optical phase demodulation signals. The wavelength demultiplexing section wavelength demultiplexes the optical correlation signals, which have been outputted from the optical phase intensity conversion section, in accordance with wavelengths of the signals, and outputs resultant signals as optical correlation signals. The optical-electrical conversion sections respectively convert the optical correlation signals, which have been outputted from the wavelength demultiplexing section, and respectively output resultant signals as correlation signals. Each of the signal identification sections identifies one of the correlation signals outputted from a corresponding one of the optical-electrical conversion sections, thereby detecting a data signal.

According to the second aspect of the present invention, optical phase modulation is performed, in accordance with the template signal, on the optical pulse signals respectively having different wavelengths which have been wavelength division multiplexed, and then resultant signals are converted by the optical phase intensity conversion section into the optical correlation signals. When the optical correlation signals are outputted from the optical phase intensity conversion section, the optical correlation signals are still wavelength division multiplexed. The wavelength division multiplexed optical correlation signals are wavelength demultiplexed in accordance with the wavelengths thereof by the wavelength demultiplexing section. Thereafter, the optical correlation signals are converted into electrical signals, and then data signals are detected therefrom. In the second aspect, by using cyclicity of the optical phase intensity conversion section, the optical correlation signals which are wavelength division multiplexed can be obtained. Thus, the ultra wideband communication system, which is capable of performing wavelength division multiplexing and in which the number of component elements provided for correlation processing is not required to correspond to the number of wavelengths, is provided.

Preferably, an interval between each of wavelengths of the plurality of optical pulse signals is an integral multiple of a free spectrum range of the optical phase intensity conversion section.

As a result, optical-electrical conversion is performed when each of optical intensities of optical phase signals is optimal. Therefore, a transmission quality is expected to be optimally improved.

As one embodiment, the first optical phase modulation section may perform optical phase modulation by an external modulation method.

As one embodiment, the first optical phase modulation section may perform optical phase modulation by a direct modulation method.

As one embodiment, the optical phase intensity conversion section may be structured by an interferometer.

Preferably, the optical phase intensity conversion section uses transfer factor characteristics, which are different from each other in relation to an optical phase of the optical phase demodulation signal, so as to output two optical correlation signals respectively having optical intensities which are opposite to each other with respect to a reference optical intensity, and the optical-electrical conversion section is structured by a bipolar photodiode to which the two optical correlation signals are inputted.

As a result, a correlation signal, which has an amplitude changing to plus and also to minus with respect to the GND level, is obtained. Therefore, a data signal is easily detected.

As one embodiment, the optical phase intensity conversion section may be structured by an optical filter.

As one embodiment, the optical phase intensity conversion section may be structured by an adaptive photodetector.

As one embodiment, the second optical phase modulation section may be structured by a spatial light phase modulator, and the optical transmission path may be a free space.

Preferably, the first optical phase modulation section performs, in accordance with the pulse signal, phase modulation in either one of two manners, in one of which the first optical phase modulation section performs phase modulation such that an optical phase changes in a direction from 0 to π, and in another of which the first optical phase modulation section performs phase modulation such that an optical phase changes in a direction from π to 0, and the second optical phase modulation section performs, in accordance with the template signal which is uniquely set, phase modulation in a predetermined manner regardless of the data signal, the predetermined manner being either one of two manners, in one of which the second optical phase modulation section performs phase modulation such that an optical phase changes in a direction from 0 to π, and in another of which the second optical phase modulation section performs phase modulation such that an optical phase changes in a direction from π to 0.

As a result, the optical phase demodulation signal outputted from the second optical phase modulation section is: an optical phase signal whose optical phase changes between 0 and π/2 in accordance with correlations with the template signal and the optical pulse signal; or an optical phase signal whose optical phase changes between π/2 and π in accordance with correlations with the template signal and the optical pulse signal. Consequently, the optical correlation signal whose optical phase is in a range between 0 and π is obtained by using the optical phase intensity conversion section, from which the optical correlation signal having an optical intensity continuously changing is outputted. Thus, correlation processing is performed appropriately.

A third aspect of the present invention is an optical transmission device used in an ultra wideband communication system for converting a pulse signal into an optical pulse signal, transmitting the optical pulse signal, and demodulating the transmitted optical pulse signal, the device comprising: a pulse generation section for generating the pulse signal based on a data signal; and an optical phase modulation section for, in accordance with the pulse signal generated by the pulse generation section, performing optical phase modulation, and outputting a resultant signal as an optical pulse signal. The optical phase modulation section performs phase modulation in either one of two manners, in one of which the optical phase modulation section performs phase modulation so as to cause an optical phase to change in a direction from 0 to π, and in another of which the optical phase modulation section performs phase modulation so as to cause an optical phase to change in a direction from π to 0, such that: after the optical pulse signal is propagated through the optical transmission path, optical phase modulation is performed on the optical pulse signal in accordance with a predetermined template signal having a correlation with the pulse signal, in order for the optical pulse signal to be converted into an optical phase demodulation signal; information about an optical phase of the optical phase demodulation signal is converted into information about an optical intensity thereof, in order for the optical phase demodulation signal to be converted into an optical correlation signal; and optical-electrical conversion is performed on the optical correlation signal in order for the optical correlation signal to be converted into a correlation signal.

According to the third aspect of the present invention, the optical transmission device capable of improving a quality of correlation processing is provided.

A fourth aspect of the present invention is an optical reception device used in an ultra wideband communication system for converting a pulse signal into an optical pulse signal, transmitting the optical pulse signal, and demodulating the transmitted optical pulse signal, the device comprising: a template generation section for generating a pulse which has a correlation with the pulse signal and which has a predetermined waveform, and outputting the pulse as a template signal; an optical phase modulation section for, in accordance with the template signal outputted from the template generation section, performing optical phase modulation on the optical pulse signal, on which optical phase modulation has been performed such that an optical phase of the optical pulse signal changes in a direction from 0 to π, or in a direction from π to 0, and for outputting a resultant signal as an optical phase demodulation signal; an optical phase intensity conversion section for converting information about an optical phase of the optical phase demodulation signal outputted from the optical phase modulation section into information about an optical intensity thereof, and outputting a resultant signal as anoptical correlation signal; an optical-electrical conversion section for performing optical-electrical conversion on the optical correlation signal outputted from the optical phase intensity conversion section, and outputting a resultant signal as a correlation signal; and a signal identification section for detecting a data signal by identifying the correlation signal outputted from the optical-electrical conversion section.

According to the fourth aspect of the present invention, the optical reception device capable of improving a quality of correlation processing is provided.

A fifth aspect of the present invention is an optical repeater used in an ultra wideband communication system for performing wavelength division multiplexing of a plurality of optical pulse signals, on each of which optical phase modulation has been performed in accordance with a plurality of pulse signals, transmitting the plurality of optical pulse signals, and wavelength demultiplexing the plurality of transmitted optical pulse signals to demodulate the optical pulse signals. The optical pulse signals are signals, on each of which optical phase modulation has been performed such that an optical phase of each of the optical pulse signals changes in a direction from 0 to π, or in a direction from π to 0. The optical repeater comprises: a template generation section for generating a pulse which has a correlation with each of the pulse signals and which has a predetermined waveform, and outputting the pulse as a template signal; an optical phase modulation section for, in accordance with the template signal outputted from the template generation section, performing optical phase modulation on the plurality of optical pulse signals which have been wavelength division multiplexed, and outputting resultant signals as optical phase demodulation signals which have been wavelength division multiplexed; and an optical phase intensity conversion section for converting information about an optical phase of each of the optical phase demodulation signals, which have been wavelength division multiplexed and which have been outputted from the optical phase modulation section, into information about an optical intensity thereof, and outputting resultant signals as optical correlation signals having been wavelength division multiplexed.

According to the fifth aspect of the present invention, optical phase modulation is performed on wavelength division multiplexed optical pulse signals, while the signals are kept wavelength division multiplexed, and as a result, wavelength division multiplexed optical phase demodulation signals are obtained. Further, optical phases of the wavelength division multiplexed optical phase demodulation signals are converted into optical intensities, and as a result, wavelength division multiplexed optical correlation signals are obtained. Thus, the optical repeater, which is used in the ultra wideband communication system and which is not required to have the number of optical devices corresponding to the number of wavelengths, is provided.

### Effect of the Invention

In the ultra wideband communication device according to the present invention, an optical device, by which a wideband frequency characteristic is obtained more easily than by a conventional correlator (electrical mixer), can be used, and thereby a quality of correlation processing is improved. When wavelength division multiplexing is performed, the cyclicity of the transfer factor characteristic of the interferometer is used so that the optical device can be commonly used. This reduces the number of component elements within the ultra wideband communication device, and thereby improving applicability of the ultra wideband communication device for wavelength division multiplexing.

These and other objects, features, aspects and advantages of the present invention will become more apparent from the following detailed description of the present invention when taken in conjunction with the accompanying drawings.

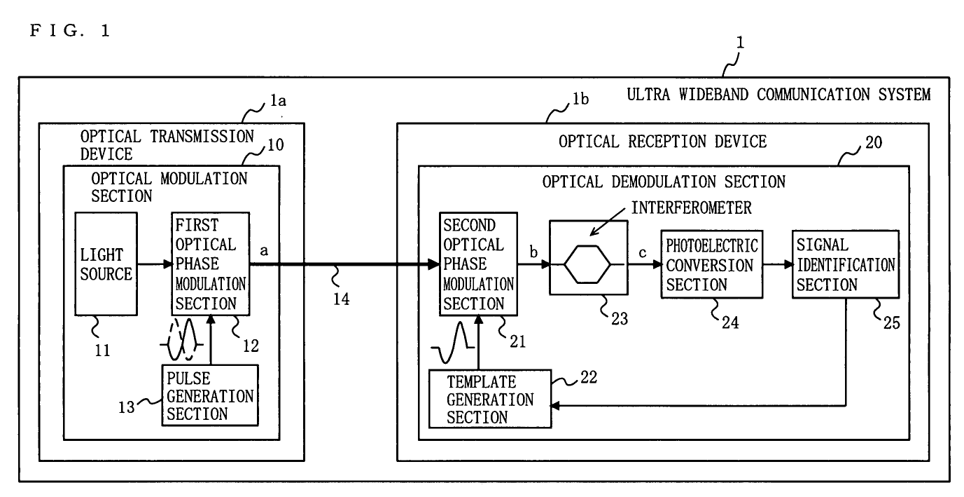

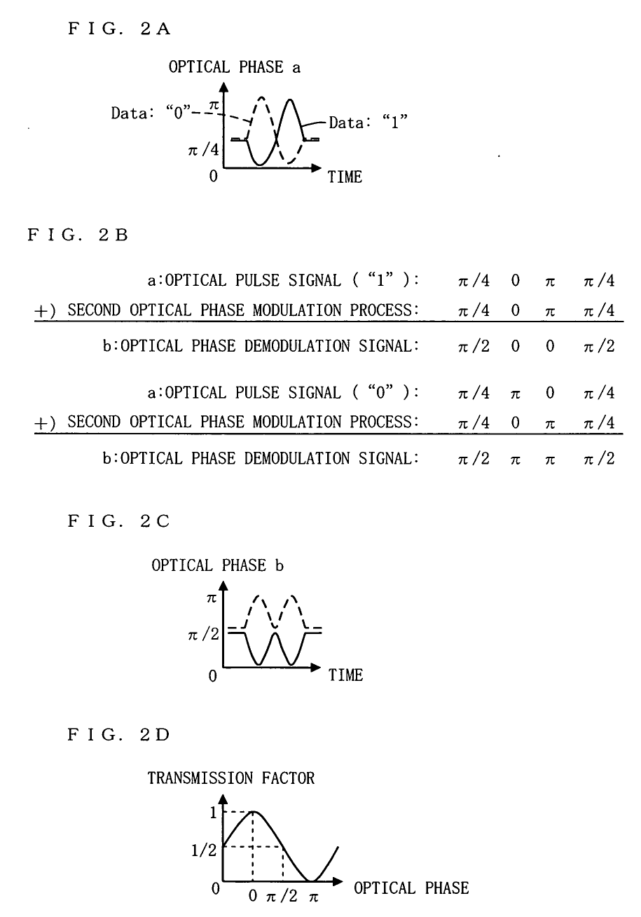

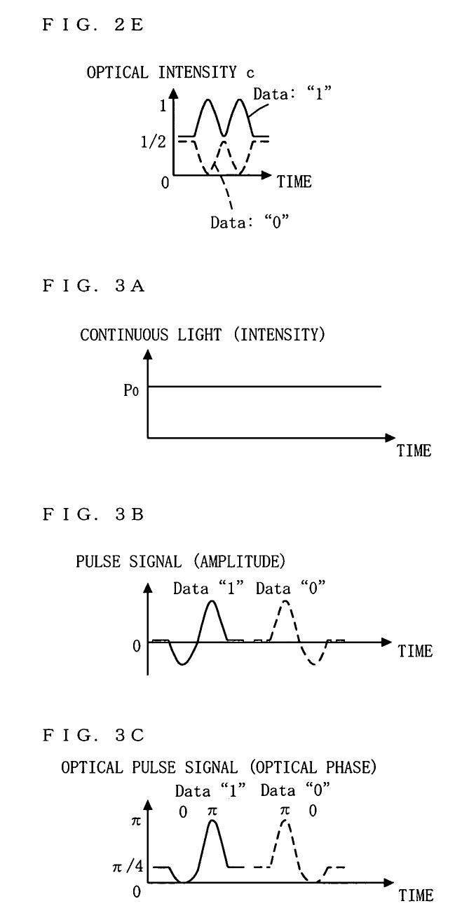

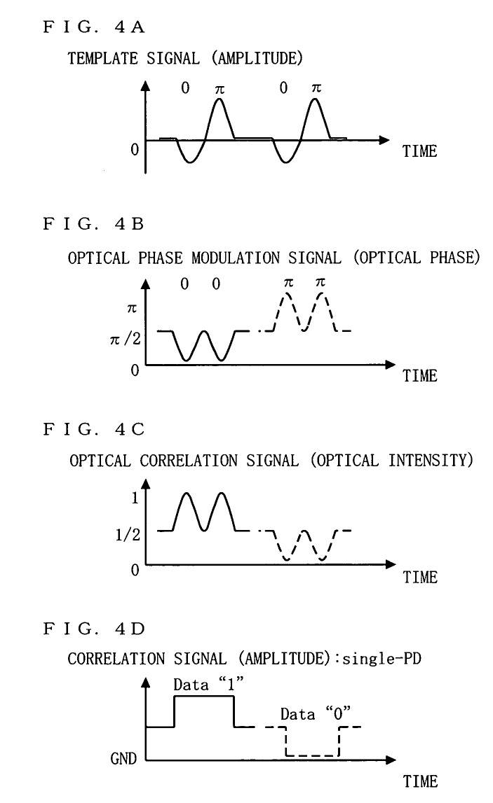

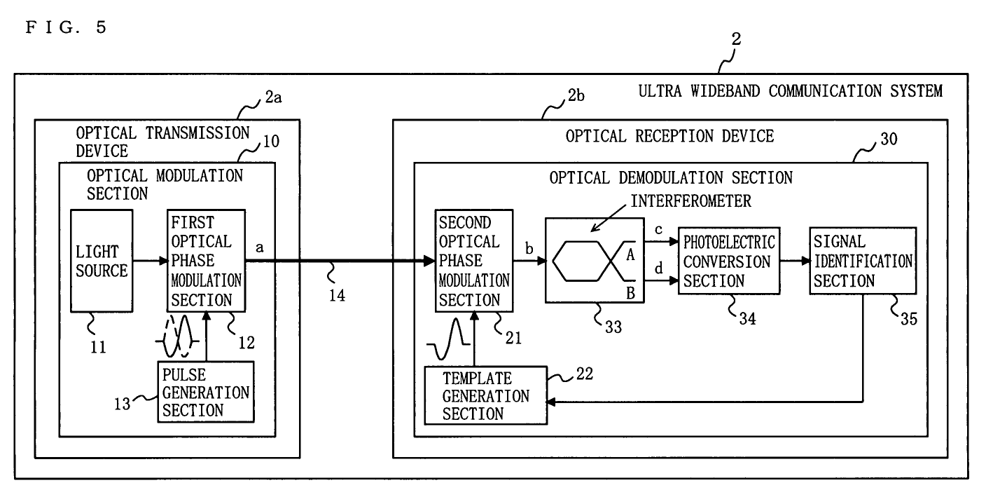

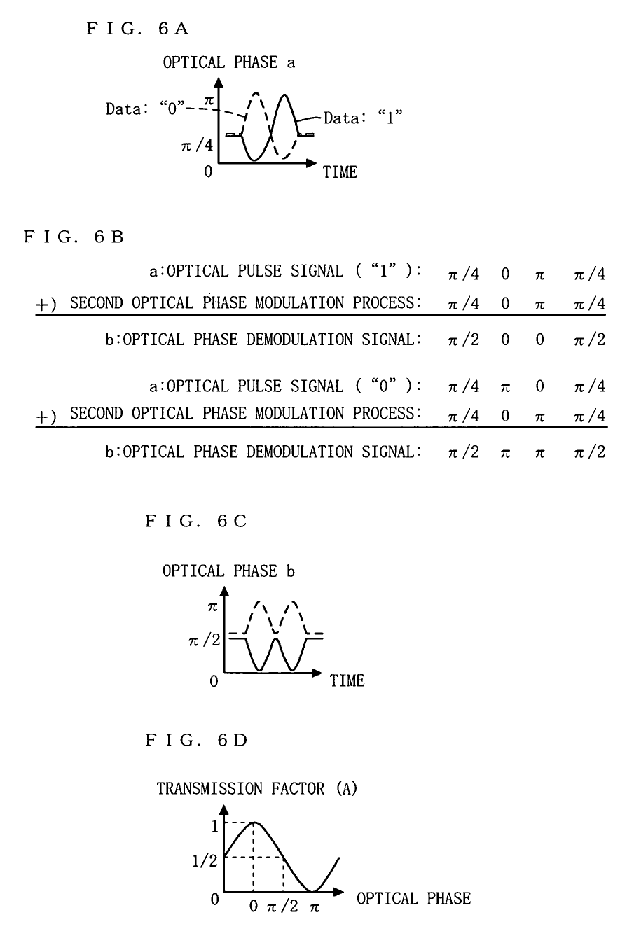

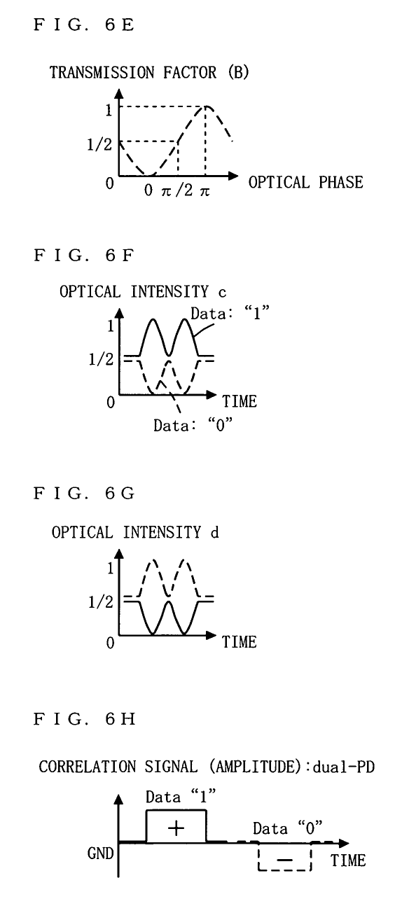

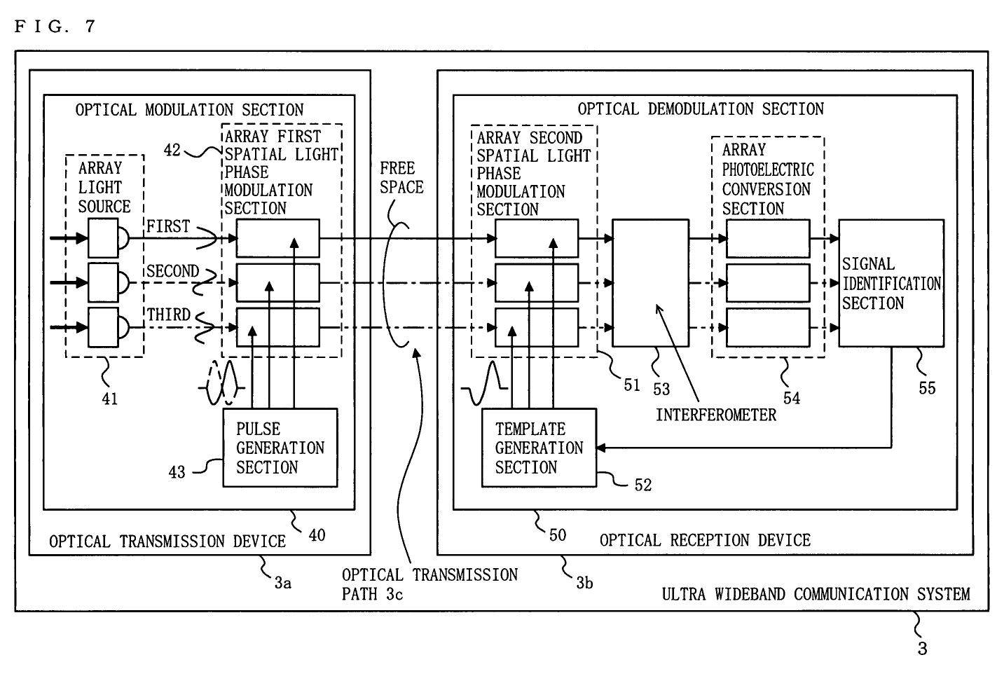

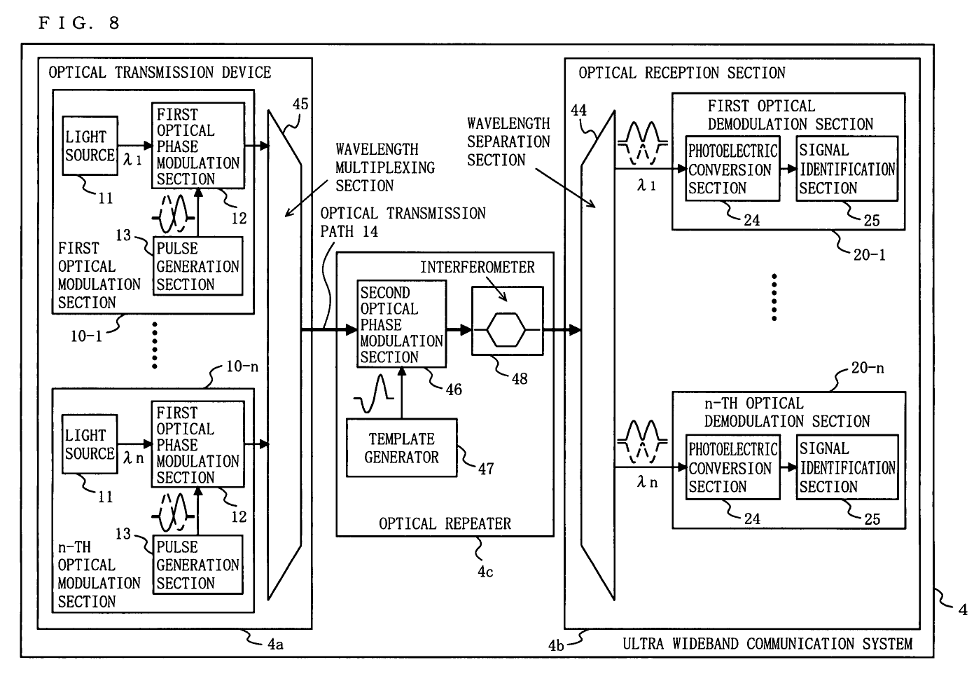

### BRIEF DESCRIPTION OF THE DRAWINGS

[FIG. 1] FIG. 1 is a block diagram showing a configuration of an ultra wideband communication system 1 according to a first embodiment of the present invention.

[FIG. 2A] FIG. 2A shows relationships between an optical phase of an optical pulse signal and time.

[FIG. 2B] FIG. 2B illustrates a manner of obtaining an optical correlation signal based on the optical pulse signal and a template signal.

[FIG. 2C] FIG. 2C shows relationships between an optical phase of an optical phase demodulation signal and time.

[FIG. 2D] FIG. 2D is a graph showing a transfer factor of an interferometer 23 in relation to an optical phase of a signal.

[FIG. 2E] FIG. 2E shows relationships between an optical intensity of an optical correlation signal and time.

[FIG. 3A] FIG. 3A shows a change occurring over time in a continuous light outputted from a light source 11.

[FIG. 3B] FIG. 3B shows amplitude changes of pulse signals outputted from a pulse generation section 13.

[FIG. 3C] FIG. 3C shows optical phase changes of the optical pulse signals outputted from a first optical phase modulation section 12.

[FIG. 4A] FIG. 4A shows an amplitude change of the template signal.

[FIG. 4B] FIG. 4B shows optical phase changes of optical phase demodulation signals outputted from a second optical phase modulation section 21.

[FIG. 4C] FIG. 4C shows changes in an optical intensity of the optical correlation signal outputted from the interferometer 23.

[FIG. 4D] FIG. 4D shows amplitude changes of correlation signals outputted from an optical-electrical conversion section 24.

[FIG. 5] FIG. 5 is a block diagram showing a configuration of an ultra wideband communication system 2 according to a second embodiment of the present invention.

[FIG. 6A] FIG. 6A shows relationships between time and an optical phase of the optical pulse signal.

[FIG. 6B] FIG. 6B illustrates a manner of obtaining the optical correlation signal based on the optical pulse signal and the template signal.

[FIG. 6C] FIG. 6C shows relationships between time and an optical phase of the optical phase demodulation signal.

[FIG. 6D] FIG. 6D is a graph showing a transfer factor at an output terminal A of an interferometer 33 in relation to a phase of a signal.

[FIG. 6E] FIG. 6E shows a graph showing a transfer factor at an output terminal B of the interferometer 33 in relation to a phase of a signal.

[FIG. 6F] FIG. 6F shows relationships between time and an optical intensity of an optical correlation signal c outputted from the output terminal A.

[FIG. 6G] FIG. 6G shows relationships between time and an optical intensity of an optical correlation signal d outputted from the output terminal B.

[FIG. 6H] FIG. 6H shows a change occurring over time in the correlation signal outputted from an optical-electrical conversion section 34 in the case where a data signal is “10”.

[FIG. 7] FIG. 7 shows a configuration of an ultra wideband communication system 3 according to a third embodiment of the present invention.

[FIG. 8] FIG. 8 is a block diagram showing a configuration of an ultra wideband communication system 4 according to a fourth embodiment of the present invention.

[FIG. 9A] FIG. 9A is a block diagram showing an ultra wideband communication system as a result of: extracting, from a conventional ultra wideband communication system disclosed in a patent document 1, component elements relating to the present invention; and adding, to the extracted component elements, component elements required for optical transmission which are disclosed in International Publication WO 2004/082175.

[FIG. 9B] FIG. 9B shows waveforms of pulse signals outputted from a pulse generation section 92.

[FIG. 9C] FIG. 9C shows waveforms of optical pulse signals outputted from an electrical-optical conversion section 93.

### DESCRIPTION OF THE REFERENCE CHARACTERS

1, 2, 3, 4 ultra wideband communication systems

1a, 3a, 4 optical transmission devices

1b, 3b, 4b optical reception devices

3c, 14 optical transmission paths

4c optical repeater

10, 40 optical modulation sections

10-1 to 10-n first to nth optical modulation sections

11 light source

12 first optical phase modulation section

13, 43 pulse generation sections

20, 30, 50 optical demodulation sections

20-1 to 20-n first to nth optical demodulation sections

21 second optical phase modulation section

21-1 to 21-n first to nth optical demodulation sections

22, 47, 52 template generation sections

23, 33, 48 interferometers

24, 34 optical-electrical conversion sections

25, 35, 55 signal identification sections

45 wavelength division multiplexing section

41 array light source

46 second optical phase modulation section

42 array first spatial light phase modulation section

44 wavelength demultiplexing section

51 array second spatial light phase modulation section

53 interferometry section

54 array optical-electrical conversion section

### BEST MODE FOR CARRYING OUT THE INVENTION

Hereinafter, embodiments of the present invention will be described with reference to the drawings.

### FIRST EMBODIMENT

FIG. 1 is a block diagram showing a configuration of an ultra wideband communication system 1 according to a first embodiment of the present invention. In FIG. 1, the ultra wideband communication system 1 comprises an optical transmission device 1a, an optical transmission path 14 and an optical reception device 1b. The optical transmission device 1a includes an optical modulation section 10. The optical reception device 1b includes an optical demodulation section 20. A data signal is transmitted from the optical modulation section 10 to the optical demodulation section 20 via the optical transmission path 14. The optical modulation section 10 includes a light source 11, a first optical phase modulation section 12 and a pulse generation section 13. The optical demodulation section 20 includes a second optical phase modulation section 21, a template generation section 22, an interferometer 23 which is an optical phase intensity conversion section, an optical-electrical conversion section 24 and a signal identification section 25.

The optical modulation section 10 converts an electrical pulse signal, which is generated based on a data signal to be transmitted (hereinafter, the electrical pulse signal will be simply referred to as a pulse signal), into a light pulse signal (hereinafter, the light pulse signal will be referred to as an optical pulse signal), and outputs the optical pulse signal. The optical pulse signal outputted from the optical modulation section 10 is propagated through the optical transmission path 14, and inputted into the optical demodulation section 20. The optical demodulation section 20 demodulates the propagated optical pulse signal to obtain the original data signal.

Operations performed in the first embodiment of the present invention will be described below. In the optical modulation section 10, the light source 11 emits a continuous light. The pulse generation section 13 generates a pulse signal based on a data signal to be transmitted. The first optical phase modulation section 12 performs, in accordance with the pulse signal outputted from the pulse generation section 13, optical phase modulation on the light from the light source 11, and outputs a resultant signal as an optical pulse signal a (for details, refer to later-described FIG. 2A). Hereinafter, an optical phase modulation process performed by the first optical phase modulation section 12 will be referred to as a first optical phase modulation process.

The optical transmission path 14 propagates the optical pulse signal a outputted from the first optical phase modulation section 12.

In the optical demodulation section 20, the template generation section 22 generates, in accordance with a synchronization timing outputted from the later-described signal identification section 25, a predetermined pulse having a correlation with the pulse signal outputted from the pulse generation section 13, and outputs the pulse as a template signal. Here, having a correlation with the pulse signal means that an amplitude of the template signal changes in a same direction as that of an amplitude change of the pulse signal, or that the amplitude of the template signal changes in an opposite direction to that of the amplitude change of the pulse signal. The second optical phase modulation section 21 performs, in accordance with the template signal outputted from the template generation section 22, optical phase modulation on the optical pulse signal having propagated through the optical transmission path 14, and outputs a resultant signal as an optical phase demodulation signal b. The interferometer 23 may be structured by, e.g., a Mach-Zehnder interferometer. The interferometer 23 changes information about an optical phase of the optical phase demodulation signal b outputted from the second optical phase modulation section 21 (hereinafter, referred to as optical phase demodulation information) into information about an optical intensity thereof (hereinafter, referred to as optical intensity modulation information), and outputs a resultant signal as an optical correlation signal c. The optical-electrical conversion section 24 performs optical-electrical conversion of the optical correlation signal c outputted from the interferometer 23, and outputs a resultant signal as a correlation signal. The signal identification section 25 identifies the correlation signal outputted from the optical-electrical conversion section 24, thereby detecting the data signal transmitted from the optical modulation section 10.

Note that, the signal identification section 25 detects the synchronization timing for detecting the data signal, and inputs the synchronization timing into the template generation section 22. An exemplary manner of detecting the synchronization timing is that the signal identification section 25 sweeps, in a time direction, the template signal outputted from the template generation section 22, and integrates the correlation signal over a predetermined time cycle (e.g., a time cycle of the template signal), and then outputs a timing, at which an integration value becomes greatest, as the synchronization timing. A manner of detecting the synchronization timing is not limited thereto. The synchronization timing maybe inputted into the template generation section 22 from a function block which is different from the signal identification section 25.

FIG. 2A shows relationships between an optical phase of the optical pulse signal and time. As shown in FIG. 2A, the optical pulse signal corresponding to data “1” is a signal whose optical phase changes from π/4 to 0 to π, and then returns from π to π/4. Also, the optical pulse signal corresponding to data “0” is a signal whose optical phase changes from π/4 to π to 0, and then returns from 0 to π/4. To be specific, there are two cases: in one of which the first optical phase modulation section 12 performs, in accordance with the data signal, i.e., the pulse signal, optical phase modulation such that the optical phase of the optical pulse signal changes in a direction from 0 to π; and in the other of which the first optical phase modulation section 12 performs, in accordance with the data signal, i.e., the pulse signal, optical phase modulation such that the optical phase of the optical pulse signal changes in a direction from π to 0.

Here, it is assumed that the template signal used for optical phase modulation has a same phase change as that of the optical pulse signal corresponding to the data “1”. In other words, the template signal has a phase changing from π/4 to 0 to π, and then returns from π to π/4. Hereinafter, phase modulation performed in accordance with the template signal will be referred to as a second phase modulation process (template process).

FIG. 2B illustrates a manner of obtaining the optical correlation signal based on the optical pulse signal and template signal. As shown in FIG. 2B, when optical phase modulation is performed, in accordance with the template signal, on the optical pulse signal corresponding to the data “1”, the optical phase of the optical correlation signal is the sum of the optical phases of the optical pulse signal and an optical signal which results from the second phase modulation process. Similarly, when optical phase modulation is performed, in accordance with the template signal, on the optical pulse signal corresponding to the data “0”, the optical phase of the optical correlation signal is the sum of the optical phases of the optical pulse signal and an optical signal which results from the second phase modulation process.

FIG. 2C shows relationships between an optical phase of the optical phase demodulation signal and time. As a result of the addition calculations shown in FIG. 2B, the optical phase demodulation signal, whose optical phase has either one of the relationships with time as shown in FIG. 2C, is outputted from the second optical phase modulation section 21.

FIG. 2D is a graph showing a transfer factor of the interferometer 23 in relation to an optical phase of a signal. As shown in FIG. 2D, the transfer factor of the interferometer 23 changes in accordance with the optical phase. The interferometer 23 functions as the optical phase intensity conversion section for converting the optical phase into an optical intensity.

FIG. 2E shows relationships between an optical intensity of the optical correlation signal and time. When the optical phase demodulation signal having either one of the optical phases shown in FIG. 2C is inputted into the interferometer 23 having the transfer factor shown in FIG. 2D, a light having an intensity corresponding to said either one of the optical phases is outputted as the optical correlation signal from the interferometer 23 as shown in FIG. 2E. A transfer factor characteristic of the interferometer 23 illustrated in FIG. 2D shows that the closer to 0 the optical phase is, the higher is the transfer factor, and the closer to π the optical phase is, the lower is the transfer factor. Accordingly, as shown in FIG. 2E, an optical phase, which is equal to or smaller than π/2,of the optical phase demodulation signal corresponding to the data signal “1” corresponds to an optical intensity changing between ½ and 1 (here, ½ and 1 are relative values), and an optical phase, which is equal to or greater than π/2,of the optical phase demodulation signal corresponding to the data signal “0” corresponds to an optical intensity changing between 0 and ½.

Next, operations of the ultra wideband communication system 1 will be described by using specific exemplary data. Here, it is assumed that a data signal to be transmitted is “10”.

FIG. 3A shows a change occurring over time in a continuous light outputted from the light source 11. As shown in FIG. 3A, an intensity of the continuous light remains same as the time passes.

FIG. 3B shows amplitude changes of pulse signals outputted from the pulse generation section 13. As shown in FIG. 3B, the pulse generation section 13 outputs, for the data signal “1”, a pulse signal whose amplitude changes from minus to plus, and outputs, for the data signal “0”, a pulse signal whose amplitude changes from plus to minus.

FIG. 3C shows optical phase changes of optical pulse signals outputted from the first optical phase modulation section 12. The first optical phase modulation section 12 converts information about the amplitude of the pulse signal into optical phase information, and then outputs a resultant signal as the optical pulse signal. Accordingly, as shown in FIGS. 3B and 3C, the pulse signal and optical pulse signal have a same polarity.

FIG. 4A shows the amplitude change of the template signal. As shown in FIG. 4A, the template signal has a same polarity as that of the pulse signal corresponding to the data signal “1”. The template signal is a signal having a predetermined polarity which is fixed regardless of a content of a data signal.

FIG. 4B shows optical phase changes of optical phase demodulation signals outputted from the second optical phase modulation section 21. The template signal has a polarity which is uniquely predetermined to be same as that of the pulse signal corresponding to the data signal “1”. In accordance with the template signal having the uniquely predetermined polarity, the second optical phase modulation section 21 performs phase modulation on a signal inputted thereto, such that, regardless of the content of the data signal, the optical phase of the inputted signal changes in the direction from 0 to π. Accordingly, in the case where the optical pulse signal has a same polarity as that of a signal used to perform the second phase modulation process, the second optical phase modulation section 21 outputs the optical phase demodulation signal having optical phase information changing between π/2 and 0. Whereas, in the case where the optical pulse signal has a different polarity from that of the signal used to perform the second phase modulation process, the second optical phase modulation section 21 outputs the optical phase demodulation signal having an optical phase changing between π/2 and π. This means that the second optical phase modulation section 21 has added, as shown in the addition calculations of FIG. 2B, optical phase information about the optical pulse signal to optical phase information about the signal used for the second phase modulation process.

FIG. 4C shows changes in an optical intensity of the optical correlation signal outputted from the interferometer 23. As shown in FIG. 2D, the transfer factor of the interferometer 23 changes in accordance with an optical phase of a signal. Accordingly, the interferometer 23 converts optical phase information about the optical phase demodulation signal into optical intensity information, and outputs a resultant signal as the optical correlation signal, whose light intensity is represented by a relative light intensity and which has a relative optical intensity waveform.

FIG. 4D shows amplitude changes of correlation signals outputted from the optical-electrical conversion section 24. It is assumed in FIG. 4D that a single photodiode (single-PD) is used as the optical-electrical conversion section 24. As shown in FIG. 4D, when the single photodiode is used as the optical-electrical conversion section 24, a correlation signal, whose amplitude changes within a range higher than the GND level in accordance with the optical intensity of the optical correlation signal, is outputted. The correlation signal corresponding to the data signal “1” is a high-level signal, and the correlation signal corresponding to the data signal “0” is a low-level signal.

The signal identification section 25 integrates the correlation signal over a predetermined time cycle (e.g., a time cycle of the template signal), and then compares an integration value of the correlation signal with that of the high-level signal and low-level signal, thereby recognizing whether the data signal transmitted from the optical modulation section 10 is “1” or “0”.

As described above, according to the first embodiment, optical phase modulation is performed twice, i.e., the first optical phase modulation section 12 performs optical phase modulation on the pulse signal to output a resultant signal as the optical pulse signal, and the second optical phase modulation section 21 performs optical phase demodulation on the optical pulse signal in accordance with the template signal. As a result, the sum of the optical phases of the optical pulse signal and an optical signal which results from the second phase modulation process is outputted as the optical phase demodulation signal. When the optical pulse signal outputted from the optical modulation section 10 has a reverse characteristic corresponding to that of the data signal, the optical phase demodulation signal to be outputted, which is the sum of the optical phases of the optical pulse signal and the template signal, also has the reverse characteristic. When optical phase intensity conversion is performed, by using the interferometer 23, on the optical phase demodulation signal, and the signal is converted into an optical intensity, the original data signal can be identified by using the optical-electrical conversion section 24 and the signal identification section 25. Thus, in the ultra wideband communication system according to the first embodiment, the original data signal can be identified by performing correlation processing with an optical device. Consequently, a quality of correlation processing improves as compared with conventional correlation processing performed by multiplying electrical amplitudes.

In the first embodiment, an external modulation method has been described in which the first optical phase modulation section modulates the optical phase of the continuous light emitted from the light source. However, optical phase modulation may be performed by a direct modulation method.

Further, in the first embodiment, a pulse corresponding to the data signal “1” is used as the template signal. However, a pulse corresponding to the data signal “0” may be used as the template signal. In such a case, the second optical phase modulation section 21 performs, in accordance with the template signal having a uniquely determined polarity, phase modulation such that the optical phase of an inputted signal changes in a direction from π to 0 regardless of the data signal. Although some signals have opposite polarities to those of the other signals, phase modulation is performed for each signal in a same manner as that described above.

Although the interferometer 23 is used as the optical phase intensity conversion section in the first embodiment, an optical filter, an adaptive photodetector or the like may be used as the optical phase intensity conversion section. In other words, used as the optical phase intensity conversion section may be an optical device capable of outputting an optical signal which has an optical intensity corresponding to an optical phase of an optical signal inputted to the optical device. The adaptive photodetector is described in detail in the following document: Celis, M.; Hernandez, D.; Rodriguez, P.; Stepanov, S.; Korneev, N., “Polarization-independent linear detection of optical phase modulation using photo-emf adaptive photodetectors”, Technical Digest. Summaries of papers presented at the Conference on Lasers and Electro-Optics(CLEO) 98., 1998, 3-8 May 1998 Page(s):530-531.

### SECOND EMBODIMENT

FIG. 5 is a block diagram showing a configuration of an ultra wideband communication system 2 according to a second embodiment of the present invention. In FIG. 5, component elements which are identical with those of the first embodiment are denoted by same reference numerals as those used for the component elements of the first embodiment, and detailed descriptions thereof will be omitted. The optical demodulation section 30 according to the second embodiment comprises the second optical phase modulation section, the template generation section 22, an interferometer 33, an optical-electrical conversion section 34 and a signal identification section 35.

FIG. 6A shows relationships between time and an optical phase of an optical pulse signal. FIG. 6B illustrates a manner of obtaining an optical correlation signal based on an optical pulse signal and a template signal. FIG. 6C shows relationships between time and an optical phase of the optical phase demodulation signal. FIGS. 6A to 6C are identical with FIGS. 2A to 2C of the first embodiment.

The interferometer 33 has two output terminals. In response to an inputted optical phase demodulation signal, the interferometer 33 generates pieces of optical intensity modulation information which are in opposite phase to each other, and then outputs two optical correlation signals c and d. The interferometer 33 maybe a Mach-Zehnder interferometer, for example. Here, the pieces of optical intensity modulation information being in opposite phase to each other means that when optical intensity changes, each of which corresponds to an optical phase of the inputted optical phase demodulation signal, are represented by waveforms as shown in FIGS. 6D and 6E, the waveforms are in opposite phase. In other words, the interferometer 33 converts, by using two transfer factor characteristics which are opposite to each other, a piece of optical phase modulation information about the inputted optical phase demodulation signal into two pieces of optical intensity modulation information. As a result, the interferometer 33 outputs two optical correlation signals (refer to later-described FIGS. 6F and 6G) respectively having pieces of optical intensity information which are opposite to each other. Here, the pieces of optical intensity information, which are opposite to each other, respectively represent optical intensities respectively having polarities which are opposite to each other with respect to a particular reference optical intensity (e.g., ½ in FIGS, 6F and 6G).

The optical-electrical conversion section 34 is structured by a bipolar photodiode.

FIG. 6D is a graph showing, in relation to a phase of a signal, a transfer factor at an output terminal A of the interferometer 33. FIG. 6E is a graph showing, in relation to a phase of a signal, a transfer factor at an output terminal B of the interferometer 33. FIG. 6F shows relationships between time and an optical intensity of the optical correlation signal c outputted from the output terminal A. FIG. 6G shows relationships between time and an optical intensity of the optical correlation signal d outputted from the output terminal B.

As shown in FIGS. 6D and 6E, the interferometer 33 has two transfer factor characteristics which are opposite to each other. By using optical phase dependency of a transfer factor (A), the interferometer 33 outputs an optical phase demodulation signal inputted from the output terminal A as the optical correlation signal c. By using optical phase dependency of a transfer factor (B), the interferometer 33 outputs the optical phase demodulation signal inputted from the output terminal B as the optical correlation signal d. A relationship between FIG. 6D and FIG. 6F is same as that between FIG. 2D and FIG. 2E. The transfer factor characteristic illustrated in FIG. 6E shows that the closer to 0 the phase of a signal is, the lower is the transfer factor, and the closer to π the phase is, the higher is the transfer factor. Accordingly, as shown in FIG. 6G, a phase, which is equal to or smaller than π/2, of the optical phase demodulation signal corresponding to the data signal “1” corresponds to an optical intensity changing between 0 and ½, and a phase, which is equal to or greater than π/2, of the optical phase demodulation signal corresponding to the data signal “0” corresponds to an optical intensity changing between ½ and 1.

FIG. 6H shows a change occurring over time in the correlation signal outputted from the optical-electrical conversion section 34 in the case where the data signal is “10”. Here, a bipolar photodiode is used as the optical-electrical conversion section 34. Since the optical correlation signals shown in FIGS. 6F and 6G are inputted into the optical-electrical conversion section 34, the correlation signal has an amplitude changing to plus and also to minus with respect to the GND level.

The signal identification section 35 identifies the original data signal based on whether the amplitude of the correlation signal is in plus or minus with respect to the GND level. Thus, the correlation signal is more easily identified as compared with the first embodiment, and therefore a quality of identification is improved.

As described above, according to the second embodiment, the optical demodulation section 30 converts an optical phase of an inputted optical phase demodulation signal into two optical intensities respectively having polarities which are opposite to each other with respect to a particular reference optical intensity, thereby converting the inputted optical phase demodulation signal into two optical correlation signals, and then the two optical correlation signals are converted into an electrical signal by using a bipolar photodiode. This makes it possible to obtain a correlation signal having a polarity whose center is located at the GND level. For this reason, the signal identification section 35 can easily identify the correlation signal. This improves the quality of identification.

In the second embodiment, the interferometer 33 is used as the optical phase intensity conversion section. However, the present embodiment is not limited thereto. Used as the optical intensity conversion section may be an optical filter, an adaptive photodetector or the like which is capable of converting an optical phase of a signal into two optical intensities respectively having polarities which are opposite to each other with respect to a particular reference optical intensity, thereby converting the signal into two optical correlation signals.

Also in the second embodiment, the first optical phase modulation section may perform optical phase modulation by a direct modulation method, and a pulse corresponding to the data signal “0” may be used as the template signal.

### THIRD EMBODIMENT

FIG. 7 shows a configuration of an ultra wideband communication system 3 according to a third embodiment of the present invention. In FIG. 7, the ultra wideband communication system 3 comprises an optical transmission device 3a, an optical reception device 3b and an optical transmission path 3c which is a free space. The optical transmission device 3a includes an optical modulation section 40. The optical modulation section 40 includes an array light source 41, an array first spatial light phase modulation section 42 and a pulse generation section 43. The optical reception device 3b includes an optical demodulation section 50. The optical demodulation section 50 includes an array second spatial light phase modulation section 51, a template generation section 52, an interferometry section 53, an array optical-electrical conversion section 54 and a signal identification section 55.

The array light source 41 has a plurality of light sources (FIG. 7 illustratively shows three light sources) respectively outputting continuous lights (FIG. 7 illustratively shows first to third continuous lights).

The pulse generation section 43 outputs pulse signals based on data signals to be transmitted. Here, each pulse signal is same as that of the first embodiment.

The array first spatial light phase modulation section 42 has a plurality of spatial light phase modulation sections respectively corresponding to the light sources, and performs, in accordance with the pulse signals, phase modulation respectively on the continuous lights (FIG. 7 shows the first to third continuous lights) so as to output resultant signals to the free space as optical pulse signals. Each optical pulse signal is same as that of the first embodiment. Japanese Patent Application No. 2004-295343 describes a spatial light phase modulation section in detail. For example, there has been a spatial light phase modulator using crystal liquid. To be more specific, there has been a liquid crystal spatial light modulator called PAL-SLM manufactured by Hamamatsu Photonics K.K.

The optical pulse signals outputted from the array first spatial light phase modulation section propagate through the free space which is the optical transmission path 3c, and enter the array second spatial light phase modulation section 51. The array second spatial light phase modulation section 51 has a plurality of spatial light phase modulation sections, and performs, in accordance with template signals outputted from the template generation section 52, optical phase modulation respectively on the optical pulse signals so as to output resultant signals as a plurality of optical phase demodulation signals. Each optical phase demodulation signal is same as that of the first embodiment.

The interferometry section 53 converts pieces of information about optical phases of the optical phase demodulation signals into pieces of information about optical intensities thereof, and outputs resultant signals as optical correlation signals. Each of the optical correlation signals is same as that of the first embodiment.

The array optical-electrical conversion section 54 converts the optical correlation signals into electrical signals, and outputs the electrical signals as correlation signals. Each of the correlation signals is same as that of the first embodiment.

The signal identification section 55 identifies the correlation signals. A manner of identifying the signals is same as that of the first embodiment.

As described above, the first and second optical phase modulation sections maybe spatial light phase modulation sections. Transmission of data signals maybe performed even with the optical transmission path which is a free space. By using such spatial light phase modulation sections, only an optical phase of an optical signal transmitted via the free space can be modulated without changing an amplitude of the optical signal. Since correlation processing is performed on a plurality of optical pulse signals by using same template signals, synchronizations between the template signals and the plurality of optical pulse signals are unified.

Similarly to the second embodiment, an optical phase intensity conversion section may be used instead of the interferometry section 53, the optical phase intensity conversion section being capable of converting an optical phase of each of the optical phase demodulation signals, by using transfer factor characteristics which are opposite to each other in relation to the optical phase, into two optical intensities respectively having polarities which are opposite to each other with respect to a particular reference optical intensity, thereby converting each of the optical phase demodulation signals into two optical correlation signals. In such a case, each optical-electrical conversion section in the array optical-electrical conversion section 54 may be structured by a bipolar photodiode.

### FOURTH EMBODIMENT

FIG. 8 is a block diagram showing a configuration of an ultra wideband communication system 4 according to a fourth embodiment of the present invention. The ultra wideband communication system shown in FIG. 8 is the ultra wideband communication system according to the first embodiment which is used for wavelength division multiplexed communications. In FIG. 8, component elements having same functions as those of the ultra wideband communication system shown in FIG. 1 are denoted by same reference numerals as those used for the component elements of the ultra wideband communication system shown in FIG. 1, and detailed descriptions thereof will be omitted.

In FIG. 8, the ultra wideband communication system 4 comprises an optical transmission device 4a, an optical repeater 4c, an optical reception device 4b and an optical transmission path 14 provided between the optical repeater 4c and the optical transmission device 4a. The optical transmission device 4a includes first to nth optical modulation sections 10-1 to 10-n and a wavelength division multiplexing section 45. The optical repeater 4c includes a second optical phase modulation section 46, a template generation section 47 and an interferometer 48. The optical reception device 4b includes first to nth optical demodulation sections 20-1 to 20-n and a wavelength demultiplexing section 44.

The first to nth optical modulation sections 10-1 to 10-n respectively output first to nth optical pulse signals respectively having different wavelengths. Each of the optical pulse signals is same as that of the first embodiment except that each of the optical pulse signals has a different wavelength. Here, an interval between each wavelength is an integral multiple of a free spectrum range (FSR) of an interferometer 48.

The wavelength division multiplexing section 45 performs wavelength division multiplexing of the first to nth optical pulse signals outputted from the first to nth optical modulation sections 10-1 to 10-n.

The optical transmission path 14 propagates the first to nth optical pulse signals which have been wavelength division multiplexed at the wavelength division multiplexing section 45.

The template generation section 47 generates a predetermined pulse correlated to the optical pulse signals outputted from the first to nth optical modulation sections 10-1 to 10-n, and outputs the predetermined pulse as a template signal.

The second optical phase modulation section 46 performs, in accordance with the template signal outputted from the template generation section 47, optical phase modulation on the first to nth optical pulse signals having propagated through the optical transmission path 14, and outputs resultant signals as the first to nth optical phase demodulation signals. Here, a feature of the present embodiment is that a phase of each of the first to nth optical pulse signals is modulated as a result of performing, in accordance with one template signal, optical phase modulation on the first to nth optical pulse signals which have been wavelength division multiplexed. The first to nth optical phase signals outputted from the second optical phase modulation section 46 are still wavelength division multiplexed.

The interferometer 48 converts optical phase modulation information about the first to nth optical phase demodulation signals outputted from the second optical phase modulation section 46 into optical intensity modulation information, and output resultant signals as first to nth optical correlation signals. The first to nth optical phase demodulation signals are wavelength division multiplexed before the signals are inputted into the interferometer 48, and, in accordance with cyclicity of the transfer factor characteristic of the interferometer 48, an optical phase of each of the first to nth optical phase demodulation signals is changed into an optical intensity corresponding to the optical phase. As a result, the optical phase demodulation signals are converted into the optical correlation signals. When the first to nth optical correlation signals are outputted from the interferometer 48, the signals are still wavelength division multiplexed. Here, referred to as the above-mentioned cyclicity is that a transfer factor of the interferometer 48 in relation to a wavelength of each signal inputted into the interferometer 48 cyclically reaches its peak. The wavelength of each signal inputted into the interferometer 48 maybe set at a most appropriate wavelength in accordance with such a cycle. In other words, an interval between each wavelength may be set as an integral multiple of the free spectrum range (FSR) of the interferometer 48. This allows a light to be transmitted with a maximum transfer factor. As a result, each of the optical correlation signals, which arrive the optical-electrical conversion sections 24, has a maximum optical intensity. Thus, each of the optical correlation signals has an optimal quality.

The wavelength demultiplexing section 44 wavelength demultiplexes the first to nth optical correlation signals, which have been outputted from the interferometer 48, in accordance with the wavelengths thereof.

The first to nth optical demodulation sections 20-1 to 20-n respectively correspond to the first to nth optical correlation signals which are wavelength demultiplexed in accordance with the wavelengths thereof at the wavelength demultiplexing section 44. In the first optical demodulation section 20-1, the optical-electrical conversion section 24 performs optical-electrical conversion on the first optical correlation signal, and outputs a resultant signal as a correlation signal. The signal identification section 25 identifies the correlation signal outputted from the optical-electrical conversion section 24, thereby detecting a data signal transmitted from a corresponding optical modulation section. Each of the second to nth optical demodulation sections 20-2 to 20-n operates in a same manner as that of the first optical demodulation section 20-1.

Signals subjected to optical phase modulation and optical phase demodulation in the present embodiment are same as those of the first embodiment which are shown in FIGS. 2A to 4D. However, as described above, the first to nth optical pulse signals respectively have different wavelengths; the first to nth optical phase demodulation signals respectively have different wavelengths; and the first to nth optical correlation signals respectively have different wavelengths.

As described above, in the fourth embodiment, correlation processing is performed by using the cyclicity of the transfer factor characteristic of the interferometer while keeping signals wavelength division multiplexed. This eliminates the necessity that the system has the number of component elements for correlation processing which corresponds to the number of wavelengths of the signals. This prevents a device for the system from increasing in size. Thus, the ultra wideband communication system, which is capable of performing wavelength division multiplexing, is provided.

Preferably, an interval between each of wavelengths of the first to nth optical pulse signals is an integral multiple of a free spectrum range of the optical phase intensity conversion section. Here, the free spectrum range of the optical phase intensity conversion section means one cycle during which a transfer factor of the optical phase intensity conversion section becomes maximum in relation to a wavelength of a signal. In other words, it is preferred that each of the wavelengths of the first to nth optical pulse signals is located at where the transfer factor of the optical phase intensity conversion section becomes maximum. By locating each wavelength in such a manner, optical-electrical conversion is performed when each of optical intensities of the first to nth optical correlation signals is optimal. Therefore, a transmission quality is expected to be optimally improved. Note that, in the present invention, a manner of setting an interval between each wavelength is not limited to the above since correlation processing can still be performed even if each wavelength is not located in such a manner.

The system maybe configured such that the second optical phase modulation section, the template generation section and the interferometer are provided for each wavelength. Alternatively, the system may be configured such that wavelength division multiplexing is performed on only some of the optical pulse signals, and the second optical phase modulation section, the template generation section and the interferometer are commonly used for said some of the optical pulse signals which have been wavelength division multiplexed.

In the fourth embodiment, the wavelength division multiplexing section 45 may be structured so as to output optical pulse signals into a free space, and such an array second spatial light phase modulation section as shown in FIG. 7 may be used as the second optical phase modulation section 46. This makes it possible to use the ultra wideband communication system for optical space transmission of wavelength division multiplexed signals.

While the present invention has been described in detail, the foregoing description is in all aspects illustrative and not restrictive. It is understood that numerous other modifications and variations can be devised without departing from the scope of the invention.

### INDUSTRIAL APPLICABILITY

An ultra wideband communication device according to the present invention is useful, for example, to construct a backbone for short pulse radio UWB (Ultra Wide Band) signals. Also, the ultra wideband communication device can be used as, e.g., an optical transmission device for multiplexing a short pulse signal on a CATV signal and transmitting a resultant signal, or as an optical space transmission device using a free space.

1. An ultra wideband communication system for converting a pulse signal into an optical pulse signal, transmitting the optical pulse signal, and demodulating the transmitted optical pulse signal, the system comprising:
at least one pulse generation section for generating the pulse signal based on a data signal;
at least one first optical phase modulation section for performing optical phase modulation in accordance with the pulse signal generated by the pulse generation section, and outputting a resultant signal as the optical pulse signal;
an optical transmission path for propagating the optical pulse signal outputted from the first optical phase modulation section;
a template generation section for generating a pulse which has a correlation with the pulse signal and which has a predetermined waveform, and outputting the pulse as a template signal;
a second optical phase modulation section for, in accordance with the template signal outputted from the template generation section, performing optical phase modulation on the optical pulse signal propagated through the optical transmission path, and outputting a resultant signal as an optical phase demodulation signal;
an optical phase intensity conversion section for converting information about an optical phase of the optical phase demodulation signal outputted from the second optical phase modulation section into information about an optical intensity thereof, and outputting a resultant signal as an optical correlation signal;
at least one optical-electrical conversion section for performing optical-electrical conversion on the optical correlation signal outputted from the optical phase intensity conversion section, and outputting a resultant signal as a correlation signal; and
at least one signal identification section for detecting the data signal by identifying the correlation signal outputted from the optical-electrical conversion section.

2. The ultra wideband communication system according to claim 1, wherein more than two: pulse generation sections; first optical phase modulation sections; optical-electrical conversion sections; and signal identification sections are provided, the ultra wideband communication system further comprising:
a wavelength division multiplexing section for performing wavelength division multiplexing of optical pulse signals respectively outputted from the first optical phase modulation sections, and then propagating the optical pulse signals through the optical transmission path; and
a wavelength demultiplexing section provided on an output side of the optical phase intensity conversion section, wherein
the second optical phase modulation section performs, in accordance with the template signal outputted from the template generation section, optical phase modulation on a plurality of optical pulse signals multiplexed by the wavelength division multiplexing section, and outputs resultant signals as optical phase demodulation signals,
the wavelength demultiplexing section wavelength demultiplexes the optical correlation signals, which have been outputted from the optical phase intensity conversion section, in accordance with wavelengths of the signals, and outputs resultant signals as optical correlation signals,
the optical-electrical conversion sections perform optical-electrical conversion respectively on the optical correlation signals outputted from the wavelength demultiplexing section, and respectively output resultant signals as correlation signals, and
each of the signal identification sections identifies one of the correlation signals outputted from a corresponding one of the optical-electrical conversion sections, thereby detecting a data signal.

3. The ultra wideband communication system according to claim 2, wherein an interval between wavelengths of the plurality of optical pulse signals is an integral multiple of a free spectrum range of the optical phase intensity conversion section.

4. The ultra wideband communication system according to claim 1, wherein the first optical phase modulation section performs optical phase modulation by an external modulation method.

5. The ultra wideband communication system according to claim 1, wherein the first optical phase modulation section performs optical phase modulation by a direct modulation method.

6. The ultra wideband communication system according to claim 1, wherein the optical phase intensity conversion section is structured by an interferometer.

7. The ultra wideband communication system according to claim 6, wherein
the optical phase intensity conversion section uses transfer factor characteristics, which are different from each other in relation to an optical phase of the optical phase demodulation signal, so as to output two optical correlation signals respectively having optical intensities which are opposite to each other with respect to a reference optical intensity, and
the optical-electrical conversion section is structured by a bipolar photodiode to which the two optical correlation signals are inputted.

8. The ultra wideband communication system according to claim 1, wherein the optical phase intensity conversion section is structured by an optical filter.

9. The ultra wideband communication system according to claim 1 wherein the optical phase intensity conversion section is structured by an adaptive photodetector.

10. The ultra wideband communication system according to claim 1, wherein
the second optical phase modulation section is structured by a spatial light phase modulator, and
the optical transmission path is a free space.

11. The ultra wideband communication system according to claim 1, wherein
the first optical phase modulation section performs, in accordance with the pulse signal, phase modulation in either one of two manners, in one of which the first optical phase modulation section performs phase modulation such that an optical phase changes in a direction from 0 to π, and in another of which the first optical phase modulation section performs phase modulation such that an optical phase changes in a direction from πto 0, and
the second optical phase modulation section performs, in accordance with the template signal which is uniquely set, phase modulation in a predetermined manner regardless of the data signal, the predetermined manner being either one of two manners, in one of which the second optical phase modulation section performs phase modulation such that an optical phase changes in a direction from 0 to π, and in another of which the second optical phase modulation section performs phase modulation such that an optical phase changes in a direction from πto 0.

12. An optical transmission device used in an ultra wideband communication system for converting a pulse signal into an optical pulse signal, transmitting the optical pulse signal, and demodulating the transmitted optical pulse signal, the device comprising:
a pulse generation section for generating the pulse signal based on a data signal; and
an optical phase modulation section for, in accordance with the pulse signal generated by the pulse generation section, performing optical phase modulation, and outputting a resultant signal as an optical pulse signal, wherein
the optical phase modulation section performs phase modulation in either one of two manners, in one of which the optical phase modulation section performs phase modulation so as to cause an optical phase to change in a direction from 0 to π, and in another of which the optical phase modulation section performs phase modulation so as to cause an optical phase to change in a direction from π to 0, such that:
after the optical pulse signal is propagated through the optical transmission path, optical phase modulation is performed on the optical pulse signal in accordance with a predetermined template signal having a correlation with the pulse signal, in order for the optical pulse signal to be converted into an optical phase demodulation signal; information about an optical phase of the optical phase demodulation signal is converted into information about an optical intensity thereof, in order for the optical phase demodulation signal to be converted into an optical correlation signal; and optical-electrical conversion is performed on the optical correlation signal in order for the optical correlation signal to be converted into a correlation signal.

13. An optical reception device used in an ultra wideband communication system for converting a pulse signal into an optical pulse signal, transmitting the optical pulse signal, and demodulating the transmitted optical pulse signal, the device comprising:
a template generation section for generating a pulse which has a correlation with the pulse signal and which has a predetermined waveform, and outputting the pulse as a template signal;
an optical phase modulation section for, in accordance with the template signal outputted from the template generation section, performing optical phase modulation on the optical pulse signal, on which optical phase modulation has been performed such that an optical phase of the optical pulse signal changes in a direction from 0 to π, or in a direction from π to 0, and for outputting a resultant signal as an optical phase demodulation signal;
an optical phase intensity conversion section for converting information about an optical phase of the optical phase demodulation signal outputted from the optical phase modulation section into information about an optical intensity thereof, and outputting a resultant signal as an optical correlation signal;
an optical-electrical conversion section for performing optical-electrical conversion on the optical correlation signal outputted from the optical phase intensity conversion section, and outputting a resultant signal as a correlation signal; and
a signal identification section for detecting a data signal by identifying the correlation signal outputted from the optical-electrical conversion section.

14. An optical repeater used in an ultra wideband communication system for performing wavelength division multiplexing of a plurality of optical pulse signals, on each of which optical phase modulation has been performed in accordance with a plurality of pulse signals, transmitting the plurality of optical pulse signals, and wavelength demultiplexing the plurality of transmitted optical pulse signals to demodulate the optical pulse signals, wherein
the optical pulse signals are signals, on each of which optical phase modulation has been performed such that an optical phase of each of the optical pulse signals changes in a direction from 0 to π, or in a direction from π to 0, the optical repeater comprising:
a template generation section for generating a pulse which has a correlation with each of the pulse signals and which has a predetermined waveform, and outputting the pulse as a template signal;
an optical phase modulation section for, in accordance with the template signal outputted from the template generation section, performing optical phase modulation on the plurality of optical pulse signals which have been wavelength division multiplexed, and outputting resultant signals as optical phase demodulation signals which have been wavelength division multiplexed; and
an optical phase intensity conversion section for converting information about an optical phase of each of the optical phase demodulation signals, which have been wavelength division multiplexed and which have been outputted from the optical phase modulation section, into information about an optical intensity thereof, and outputting resultant signals as optical correlation signals having been wavelength division multiplexed.
